(19) United States
(12) Patent Application Publication
(10) Pub. No.: US 2012/0156898 A1
(43) Pub. Date: Jun. 21, 2012

(54) Connection Of Printed Circuit Boards

(76) Inventor: Werner Kallee, Bad Friedrichshall (DE)

(21) Appl. No.: 13/319,744

(22) PCT Filed: May 7, 2010
(86) PCT No.: PCT/EP2010/056263

§ 371 Date: Jan. 20, 2012

(30) Foreign Application Priority Data
May 12, 2009 (DE) 102009021730.4

(51) Int. Cl. H01R 12/52

(52) U.S. Cl. 439/65

(57) ABSTRACT

In order to mechanically and electrically connect two printed circuit boards (26, 27) in a parallel arrangement, a plurality of connecting elements (1) is arranged in an insulating member (22) having parallel faces, said connecting elements projecting from both opposite faces of the insulating member. The projecting part of the connecting elements is designed as a contact element (6), thus allowing said contact elements to be plugged into plated-through bores (28) of the printed circuit boards. The contact elements are secured within the plated-through bores by means of a clamping force acting transverse to the plugging direction. The clamping force causes the contact elements to be pressed against the walls of the plated-through bores and thus both mechanically secures the contact elements and establishes an electric connection. According to the invention, the clamping force of the connecting elements is greater for one printed circuit board than the clamping force of the connecting elements for the other printed circuit board so as to ensure that the insulating member remains plugged in one of the printed circuit boards along with the connecting elements contained in the insulating member when the connection is released.

The invention relates to an arrangement for connecting printed circuit boards.

It is known that a plurality of printed circuit boards which have to be functionally connected to one another can also be arranged in electrical or electronic devices. This can be done, for example, by the printed circuit boards being arranged in a frame which also accommodates electrical connections, so that a plurality of printed circuit boards can also be electrically connected to one another by means of the frame.

However, it is also already known to directly connect two printed circuit boards to one another in parallel with one another. Plug connections are also known for this purpose.

In the case of such a connecting arrangement of two printed circuit boards with the aid of plug devices, the plug connection has two identical parts, of which each part contains a housing and plug pins and plug sockets. Each of the two elements is connected to one of the two printed circuit boards which are to be connected, specifically using surface mounted technology (SMT). In that case, the two printed circuit boards can be connected to one another by plug connection, with the plug pins of the two halves of the plug connection engaging in the plug sockets of the respectively other half. This connection is also detachable (U.S. Pat. No. 5,498,167).

In a similar arrangement, the plug connection likewise has two parts, of which one part has a housing and plug pins and the other part has a housing and plug sockets. Each part is connected to one of the two printed circuit boards using SMT, and the printed circuit boards can then be connected to one another by means of the plug pins engaging in the plug sockets. Two housing parts are required in this case too (EP 835538 B1).

The invention is based on the object of providing a possible way of connecting printed circuit boards directly to one another with little outlay.

In order to achieve this object, the invention proposes a connecting arrangement having the features of claim 1. Developments of the invention are the subject matter of dependent claims.

The connecting arrangement therefore contains at least one integral connecting element, of which the two ends which are connected by the central part are each in the form of a contact element. As a result, the connecting element can be inserted into a plated-through hole in the respective printed circuit board in the region of the two ends. The connecting element is fixed in this plated-through hole by clamping.

It is not necessary either to fix a connecting element by SMT or to always use two connecting elements to establish a conductive connection.

In a development of the invention, provision can be made for the connecting element to be arranged in an insulating body, specifically in such a way that the contact elements which are formed at the two ends of the central part in each case project out of another end surface of the insulating body.

The insulating body serves to combine and to hold a plurality of connecting elements, particularly when there is a plurality of connecting elements, so that the arrangement can be handled more easily.

In a further development of the invention, provision can be made for the end faces of the insulating body, from which the contact elements project, to form abutment surfaces for the printed circuit boards which are to be connected to one another. This leads to the connecting element being pushed into the hole in the printed circuit board until the printed circuit board bears against the end surface of the insulating body. At the same time, this limits the penetration depth of the contact elements into the hole in the printed circuit board. In this way, it is possible to ensure that the contact element is arranged with the correct spatial assignment to the printed circuit board.

At the same time, the insulating body thus forms a spacer element for fixing the distance between the two printed circuit boards. However, in contrast to the prior art, only a single insulating body is required, it being possible for said insulating body to additionally be of even simpler design than the insulating bodies from the prior art.

In a development of the invention, provision can be made for the connecting element to be secured against being pulled out in the insulating body, but therefore also against being pushed out, specifically preferably in both directions. In this way, it is possible to insert the connecting elements by acting on the insulating body and not on the connecting element itself. It goes without saying that it is also possible to act on the insulating body if a connection is intended to be detached again.

The option of designing the connection as a connection which can be detached several times is determined by the choice of clamping force which is imparted to the contact element at the two ends of the connecting element.

In a development, provision can be made, in particular, for the connecting element to be held in a non-displaceable manner in the insulating body.

In a development of the invention, provision can be made for the clamping force with which the two contact elements of the connecting element act in the respective hole to have a different magnitude. Since the plated-through holes in the printed circuit boards should usually be of the same size, the different clamping force can be created by the design of the contact elements themselves.

The connecting arrangement between two printed circuit boards can, under certain circumstances, be arranged such that it is possible to not act on the insulating body itself, but only on the printed circuit board itself, in order to detach a connection. If the clamping force on the two contact elements of a connecting element were of the same magnitude, it would not be possible to predict the side on which the contact element will first be pulled out of the hole. If an insulating body with a larger number of connecting elements is used, the insulating body could tilt and thereby damage the device. If it is ensured that the clamping force at one end of the connecting element is greater than at the other end, and if all the connecting elements are arranged with the same orientation, it is ensured that the connecting arrangement is first detached from one printed circuit board and remains plug-connected to the other printed circuit board.

There are a large number of possible ways of being able to create this clamping force of different magnitude. For example, the contact element at one end can be designed differently to the contact element at the other end.

In a development of the invention, provision can be made for at least one contact element of a connecting element to have two or more contact tongues which are separated by a slot which runs in the insertion direction. The clamping force is produced by the contact tongues being pushed inward, as a result of which they produce a counterforce.

The thickness of the contact tongues transverse to the direction of the slot can be used to influence the counterforce and therefore the clamping force. In order to establish a different clamping force at the two ends of the connecting element, the thickness of the contact tongues at one end can, for example, be greater than the thickness of the contact tongues at the other end of the connecting element.

Another option is for the number of contact tongues at the two ends of the connecting element to be different.

A further possible way of influencing the clamping force is for the contact tongues to be designed to be of a different length or, in other words, for the slot between the contact tongues at the two ends of the connecting element to be made to be of a different length.

In a development of the invention, provision can be made, according to the invention, for the length of the slot between the contact tongues to be greater than the part of the contact tongues which projects out of the corresponding end face of the insulating body.

The connecting arrangement according to the invention can also be used to create a connection which can be detached only on one side of the insulating body, while it is fixed to the other side. Therefore, the contact element at one end of the connecting element can be in the form, for example, of a contact pin which is suitable for being pressed in. In this case, the connecting elements are then pressed into the plated-through holes in a printed circuit board, so that they remain fixed there and can no longer be detached without being destroyed. A detachable plug connection can then be provided on the other side. In this way, a kind of plug strip can be permanently connected to a printed circuit board.

In a further development of the invention, provision can be made for the connecting element to be secured against being pulled out in the insulating body in the region of the connecting element where the slot is present between the contact tongues. The flexibility of the contact tongues which is permitted by the longitudinal slot can then also be used to push the connecting element into the insulating body.

The connecting element is preferably arranged in a passage in the insulating body, which passage extends from one end face to the other end face of the insulating body.

Further features, details and advantages of the invention can be found in the claims and the abstract, the wording of both of which is included in the description by way of reference, in the following description of preferred embodiments of the invention and with reference to the drawing, in which:

FIG. 1 shows a detail of a stamped part for producing connecting elements;

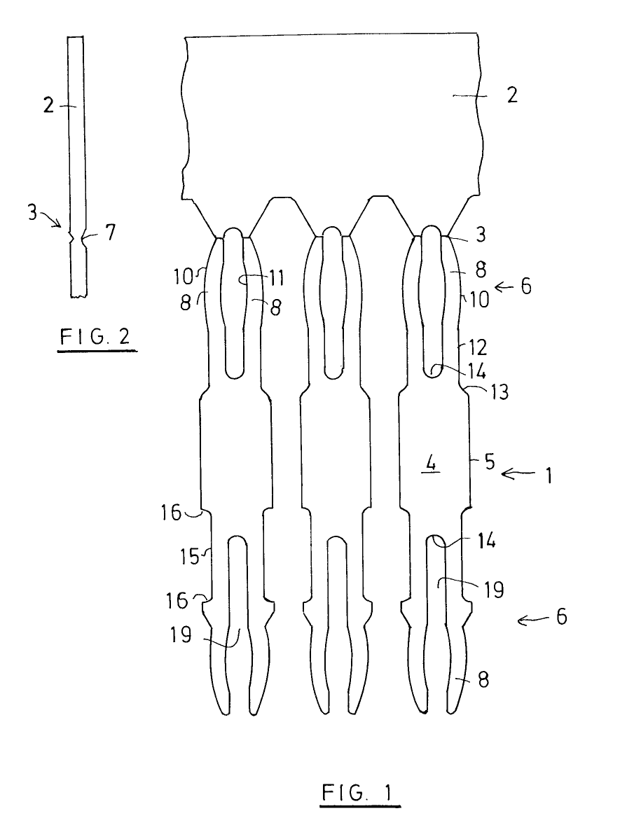

FIG. 2 shows a broken-away side view of the arrangement of FIG. 1;

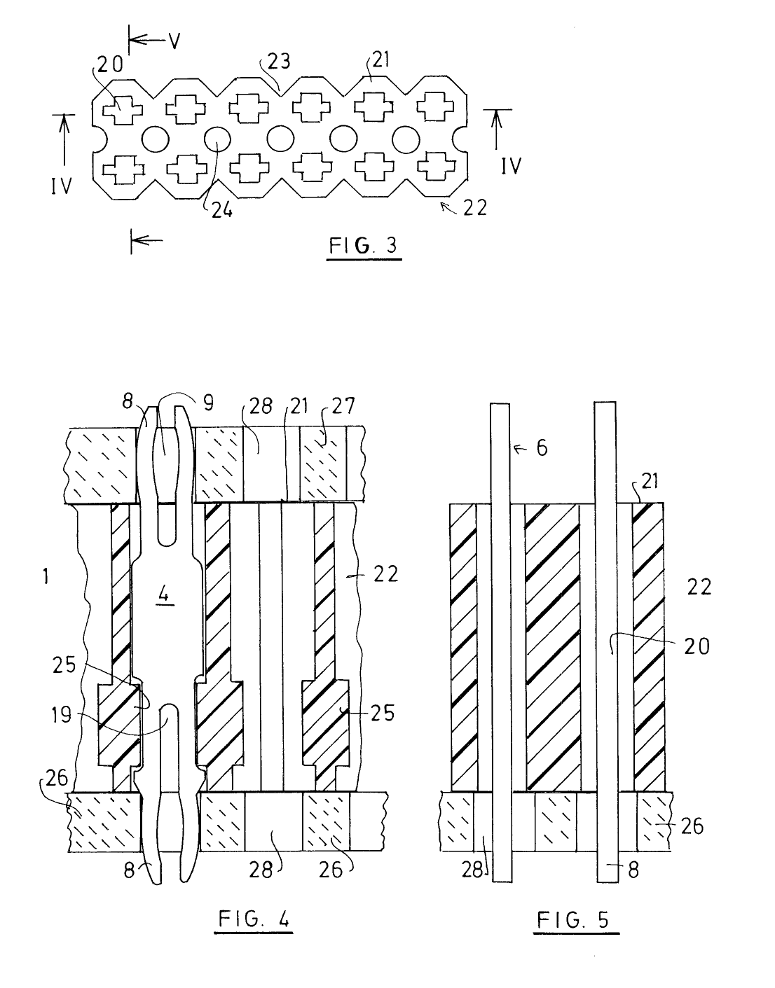

FIG. 3 shows a plan view of an insulating body for accommodating the connecting elements;

FIG. 4 shows a partial longitudinal section through the insulating body of FIG. 3 along line IV-IV; and

FIG. 5 shows a cross section through the insulating body along line V-V in FIG. 3.

The connecting arrangement, which is proposed by the invention, for electrically and mechanically connecting two printed circuit boards to one another contains a connecting element 1 which is stamped out of a piece of sheet metal. FIG. 1 shows a detail of a metal sheet which has already been stamped. The individual connecting elements 1 are attached, in a still connected state, to a sheet metal strip 2, which is still present, by means of a predetermined breaking point 3.

Each connecting element 1 contains a central part 4 which is bounded by two parallel side edges 5. The connecting element is in the form of a contact element 6 at each end of the central part 4. This applies both for that end of the connecting element 1 which is illustrated at the top in FIG. 1 and at which the connecting element is still connected to the sheet metal strip 2, and for the opposite free end which is illustrated at the bottom in FIG. 1.

As can be seen in FIG. 2, the predetermined breaking point 3 is formed by a notch 7 on the two flat sides of the sheet metal strip.

In the illustrated example, each contact element 6 contains two contact tongues 8 between which a longitudinal slot 9, 19 is formed. The longitudinal slot 9, 19 is open toward the respective free end of the contact element 6. The outwardly directed outer edge 10 of the contact tongues 8 is slightly convex, as is the inner edge 11 of the contact tongues which is directed toward the slot 9, 19.

The outer edge 12 of the contact tongues 8 is straight in the region which adjoins the central part. An oblique transition 13 is formed between the outer edge 5 of the central part 4 and the straight section 12 of the outer edge of the contact tongues 8.

That end of the slot 9 which is open toward the outer face is rounded off by a bow 14. The same bow 14 is also present at the end of the other longitudinal slot 19. The contact element 6 at the opposite end, which is at the bottom in FIG. 1, of the central part 4 is of similar design to the contact element 6 at the other end, but the longitudinal slot 19 which is present there is longer. A recess 15, which is bounded on both sides by a rounded step-like transition 16, is formed on the outer face in the transition region between the central part 4 and the contact tongues 8. This step-like transition 16 forms a stop step which runs approximately transverse to the longitudinal axis of the connecting element 1. The longitudinal slot 19 extends far into the region of this recess 15.

On account of the longer length of the longitudinal slot 19 in the contact element 6 in the lower region compared to the longitudinal slot 9 of the contact element 6 at the upper end of the connecting element 11, the lower contact element 6 yields slightly with the thickness of the contact tongues 8 otherwise being the same. A lower clamping force than the contact element 6 at the other end therefore develops when said contact element in the lower region is inserted into an opening.

FIG. 3, to which reference will now be made, shows an insulating body 22 which is designed and intended to accommodate and hold a large number of connecting elements 1. The insulating body has pairs of passages 20 which pass through from one end surface 21, which is visible in FIG. 3, of the insulating body 22 to the other end surface. The width of the insulating body 22 is reduced by notches 23 between each pair of passages 20. At the same point, there is a circular passage 24 between two notches 23 and therefore also between two adjacent pairs of passages 20. The insulating body can be easily cut to length in this way. Said insulating body can, for example, be produced with long lengths and then be shortened to the respective required length.

Each passage 20 has a cross section in the shape of a cross, with the bars of the cross which run in the longitudinal direction of the insulating body 22 being intended to accommodate in each case one connecting element 1. Therefore, in the illustrated embodiment of the insulating body, two rows of passages 20 for connecting elements are provided as a result. It goes without saying that more than two rows could also be provided. This depends on the circumstances in the individual case.

A connecting element 1 is then pushed into these passages 20 in each case, as mentioned. The result is illustrated in FIG. 4 which illustrates a longitudinal section through the insulating body in FIG. 3. The passage 20 has, in one of its end regions, an inwardly directed projection 25, the axial length of said projection between the two end faces 21 of the insulating body 22 corresponding to the length, which is measured in the same direction, of the recess 15 in the connecting elements 1. The connecting element 1 is pushed into the insulating body 22 from above in FIG. 4, with the contact tongues 8 springing inward and yielding on account of the relatively long longitudinal slot 19 in the lower region. As a result, the projection 26 on the outer face of the contact tongues 8 passes by the inwardly directed projection 25 of the insulating body 22 until it assumes the position illustrated in FIG. 4. The projection 25 then rests in the recess 15. The connecting element 1 is now secured against being pulled out of the insulating body 22 in both directions.

The contact tongues 8 project from both end surfaces 21 of the door body 22. The length of the slots 9, 19 is greater than the part of the contact tongues 8 which projects out of the insulating body 22.

The connection to two printed circuit boards 26, 27 can be established as soon as all the connecting elements 1 are arranged in the insulating body 22. For example, the insulating body is mounted on the lower printed circuit board 26 so as to be oriented in relation to the plated-through holes 28 contained in said lower printed circuit board, with the contact tongues 8 being pushed into these plated-through holes 28. Said contact tongues then bear against the wall of the holes 28 with a certain clamping force.

The upper printed circuit board 27 is then pushed onto the contact elements 6 which project out of the upper end face 21 until this printed circuit board 27 also bears against the corresponding end surface 21 of the insulating body 22. A mechanical and electrical connection is then established between the two printed circuit boards 26, 27 as a result. The two printed circuit boards are arranged parallel to one another, with the distance between them being determined by the thickness of the insulating body 22. The fixing of the connecting elements 1 in the insulating body 22 also determines the extent to which the contact elements 6 engage in the holes 28 in the printed circuit boards 26, 27.

FIG. 5 shows a cross section through the arrangement in FIG. 4, with the upper printed circuit board 27 being omitted in this case.

In the illustrated example, the connecting arrangement is designed such that it can be detached from the two printed circuit boards 26, 27 again. When the two printed circuit boards 26, 27 are pulled apart, the connection between the connecting elements 1 and the lower printed circuit board 26 is first broken since the relatively long longitudinal slot 19 is provided there.

The type of design of the contact elements 6 with two contact tongues 8 which are separated from one another by a longitudinal slot 9 or 19 which is open on one side is one of the possible ways in which the contact elements can be designed. It is also feasible to connect the contact tongues to one another in their end region, so that the longitudinal slot 9 or 19 is bounded at both ends.

Other types of design of detachable contact elements are known from the prior art.

It is also feasible for the contact element of a connecting element to be in the form of a fixed contact pin at one end, so that the insulating body is permanently pressed against a printed circuit board at one of its end faces by way of the connecting elements which are contained in said insulating body.

1. An arrangement for electrically and mechanically connecting two printed circuit boards (26, 27) to one another, containing
1.1 at least one integral connecting element (1) which has
1.2 a central part (4) and
1.3 in each case one contact element (6) at the two ends, which contact element
1.4 is designed to be inserted into a plated-through hole (28) in each case one of the two printed circuit boards (26, 27) which are to be connected,
1.5 in which plated-through hole said connecting element can be fixed transverse to the insertion direction by clamping.

2. The arrangement as claimed in claim 1, wherein the connecting element (1) is arranged in an insulating body (22) which has two end faces (21) which are averted from one another, in each case one contact element (6) projecting out of the end faces (21) of said insulating body.

3. The arrangement as claimed in claim 2, wherein the end faces (21) of the insulating body (22) form abutment surfaces for the printed circuit boards (26, 27) which are to be connected to one another.

4. The arrangement as claimed in claim 2, wherein the connecting element (1) is secured against being pulled out in both directions in the insulating body (22).

5. The arrangement as claimed in claims 2, wherein the connecting element (1) is held in a non-displaceable manner in the insulating body (22).

6. The arrangement as claimed in claim 2, wherein the clamping force of the two contact elements (6) of the connecting element (1) has a different magnitude.

7. The arrangement as claimed in claim 2, wherein the connecting element (1) is arranged in a passage (20) which extends between the two end faces (21) of the insulating body (22).

8. The arrangement as claimed in claim 1, wherein at least one contact element (6) has at least two contact tongues (8) which are separated by a slot (9, 19) which runs in the axial direction.

9. The arrangement as claimed in claim 8, wherein the thickness of the contact tongues (8) of the contact element (6) at one end of the connecting element (1) differs from the thickness of the contact tongues (8) at the other end of the connecting element (1).

10. The arrangement as claimed in claim 8, wherein the number of contact tongues (8) of the contact element (6) at one end of the connecting element (1) differs from the number of contact tongues (8) of the contact element (6) at the other end of the connecting element (1).

11. The arrangement as claimed in claims 8, wherein the length of the slot (9, 19) between the contact tongues (8) or the length of the contact tongues (8) of the contact element (6) at one end of the connecting element (1) differs from the length of the slot (9, 19) of the contact tongues (8) at the other end of the connecting element (1).

12. The arrangement as claimed in claims 8, wherein the length of the slot (9, 19) in at least one contact element (6) is greater than the part of the contact tongues (8) which projects from the insulating body (22).

13. The arrangement as claimed in claim 1, wherein at least one contact element (6) of the connecting element (1) is in the form of a contact pin which can be pressed into a plated-through hole (28) in the printed circuit board (26, 27).

14. The arrangement as claimed in claim 4, wherein the connecting element (1) is secured against being pulled out in the region of a longitudinal slot (19) between at least two contact tongues (8).

15. The arrangement as claimed in claim 1, having a large number of, in particular identical, connecting elements (1).

16. The arrangement as claimed in claim 1, wherein the connecting element (1) is stamped out of sheet metal.
